(19) United States
(12) Patent Application Publication
(10) Pub. No.: US 2013/0167665 A1
(43) Pub. Date: Jul. 4, 2013

(54) SAMPLE OBSERVATION APPARATUS

(71) Applicant: HITACHI HIGH-TECHNOLOGIES CORPORATION, Tokyo (JP)

(72) Inventors: Tetsuya NIIBORI, Mito (JP); Seiichiro KANNO, Iwaki (JP); Masaki MIZUOCHI, Hitachinaka (JP)

(73) Assignee: HITACHI HIGH-TECHNOLOGIES CORPORATION, Tokyo (JP)

(21) Appl. No.: 13/730,568

(22) Filed: Dec. 28, 2012

(30) Foreign Application Priority Data
Dec. 28, 2011 (JP) 2011-289854

(51) Int. Cl. G01N 1/28

(52) U.S. Cl. CPC G01N 1/286
USPC 73/863.01

(57) ABSTRACT

Test pieces necessary to conduct a failure analysis of defects discovered with a defect review apparatus are produced with high quality, with excellent reproducibility, in a short period of time, and at low costs. An impression marking apparatus which can be driven in a direction perpendicular to a surface of a semiconductor wafer and is equipped with an impression needle fixed on the leading end of the mechanism is attached to a wafer defect review apparatus. A position to which impression marking is applied is determined on the basis of coordinate information on a defect previously acquired with the wafer defect review apparatus. In addition, the feed rate of the impression marking mechanism in the vertical direction thereof is determined on the basis of height information acquired with a height detection sensor for detecting the height of a wafer surface provided in the wafer defect review apparatus.

### BACKGROUND OF THE INVENTION

1. Field of the Invention

The present invention relates to a wafer defect review apparatus capable of adding marks to serve as visual guides around a foreign substance or a defect on a semiconductor wafer.

2. Background Art

In the manufacture of semiconductor devices, manufacturers are asked to continue to uninterruptedly produce non-defective products. Since the amount of production is enormous, any product failure in a certain process directly leads to degradation in product yield, thus significantly affecting profitability. It is rarely possible, however, to perform production with no product failures involved. That is, product failure always occurs to some degree. Hence, a major challenge is to discover defects, foreign substances, and process failures as early as possible to reduce them. Accordingly, in a semiconductor device production site, line widths and hole dimensions are examined using a CD-SEM in the course of manufacture, and defects and foreign substances are classified and analyzed using a wafer defect review SEM. By conducting such examinations and analyses, efforts are being made to investigate failure causes and eliminate defective units.

Semiconductor wafer manufacturers are also making efforts to examine Si bare wafers for foreign substances and defects contained therein. It is difficult, however, to efficiently identify such foreign substances and defects with an electron microscope alone, since a foreign substance on an Si wafer or a defect therein is not only small in size but also present on an extremely planar surface. Thus, an optical microscope, such as a laser microscope, is applied. Hence, an inspection device which combines a CD-SEM or a defect review SEM with an optical microscope has grown popular recently.

In addition, the importance of failure analysis techniques to identify causes for discovered foreign substances and defects has grown in recent years. As one of these failure analysis techniques, a several-mm square to several-cm square test piece is produced from a semiconductor wafer and, for example, a high-resolution observation using a transmission electron microscope (TEM: Transmission Electron Microscopy) or an elemental analysis based on energy dispersive X-ray spectrometry (EDS: Energy Dispersive X-ray Spectrometry) or electron energy-loss spectroscopy (EELS: Electron Energy-Loss Spectroscopy) is conducted on the test pieces.

Unfortunately, however, it is not easy to successfully process the semiconductor wafer, so that the test piece includes a discovered foreign substance or defect. For example, using a laser or a focused ion beam (FIB: Focused Ion Beam) apparatus to process test pieces necessitates the introduction of an expensive dedicated apparatus and requires a relatively prolonged period of time in processing. If a position to be examined within the wafer is previously clear, the wafer is cleaved manually in some cases. In this case, reliance on an operator's intuition and experience is unavoidable, however. Thus, the quality of test pieces may depend on the operator's degree of proficiency. In addition, as it stands now, human eyes can hardly locate a position of cleavage in the case of an Si bare wafer. Hence, alignment marks used to process the semiconductor wafer into chips are conveniently provided at the time of performing such sample processing as described above. For example, JP 2000-241319A discloses a method for applying a marking process to around a discovered defect or foreign substance in various ways to lay out target objects which can easily be observed at the time of subsequent-stage inspection.

### SUMMARY OF THE INVENTION

JP 2000-241319A discloses a method in which position coordinates of a defect detected by defect detection means are used as a reference to put marks in the vicinity of the defect with laser light, an ion beam, an electron beam or a mechanical probe; the sample under inspection is observed with a transmission electron microscope; and a defective location is identified from the relative positional relationship between the marks and the defect to produce a sample containing the defective location of interest. The related art does not specifically disclose any low-cost, reliable marking mechanisms using an impression needle, however. It has therefore been difficult to actually create high-quality marks in a short period of time with excellent reproducibility.

An object of the present invention is to provide a wafer defect review apparatus capable of producing test pieces, with high quality, with excellent reproducibility, in a short period of time, and at low costs, necessary to conduct a failure analysis of foreign substances and defects discovered with the wafer defect review apparatus (including apparatuses of optical and electron types) for rapidly reviewing foreign substances, defects and the like on a semiconductor wafer.

In the present invention, an impression marking mechanism which can be driven in a direction perpendicular to a surface of a semiconductor wafer serving as an inspection object and is equipped with an impression needle whose leading end is acicular is attached to a wafer defect review apparatus. A position to which impression marking is applied is determined on the basis of coordinate information on a foreign substance or a defect previously acquired with the wafer defect review apparatus. In addition, the feed rate of the impression marking mechanism in the vertical direction thereof is determined on the basis of height information acquired with a height detection sensor for detecting the height of a wafer surface provided in the wafer defect review apparatus.

The impression marking mechanism preferably has a configuration in which an impression needle is fixed, in a direction perpendicular to a surface of a semiconductor wafer, on the leading end of a lever arranged almost perpendicularly to a feed mechanism movable in a direction perpendicular to the wafer surface, the mounting angle of the lever with respect to the feed mechanism is preferably made adjustable, and the impression marking mechanism is preferably provided with a load meter for measuring a pressing force applied when the impression needle of the lever makes contact with a sample.

The feed rate of the impression marking mechanism in the vertical direction thereof is preferably adjusted in at least two steps on the basis of height information acquired with the height detection sensor. This method enables impression marking in a short period of time. In addition, the feed rate of the impression marking mechanism in the vertical direction thereof is preferably controlled on the basis of the output of the load meter. This method can realize impression shapes of excellent repeatability.

According to the present invention, it is possible to form high-quality marks.

Other objects, configurations and advantageous effects than described above will become apparent from the following description of embodiments.

### BRIEF DESCRIPTION OF THE DRAWINGS

FIG. 1 is a schematic view illustrating an overall configuration example of a wafer defect review apparatus according to the present invention.

FIG. 2 is a detail view illustrating a configuration example of an impression marking apparatus.

FIG. 3 is a schematic view illustrating the relationship between the pressure and the size of an impression shape of an impression needle.

FIG. 4 is a schematic view illustrating a shape of a cutout chip.

FIG. 5 is a flowchart used to describe a flow of defect review and impression marking operation.

### DETAILED DESCRIPTION OF THE PREFERRED EMBODIMENTS

Hereinafter, embodiments of the present invention will be described with reference to the accompanying drawings.

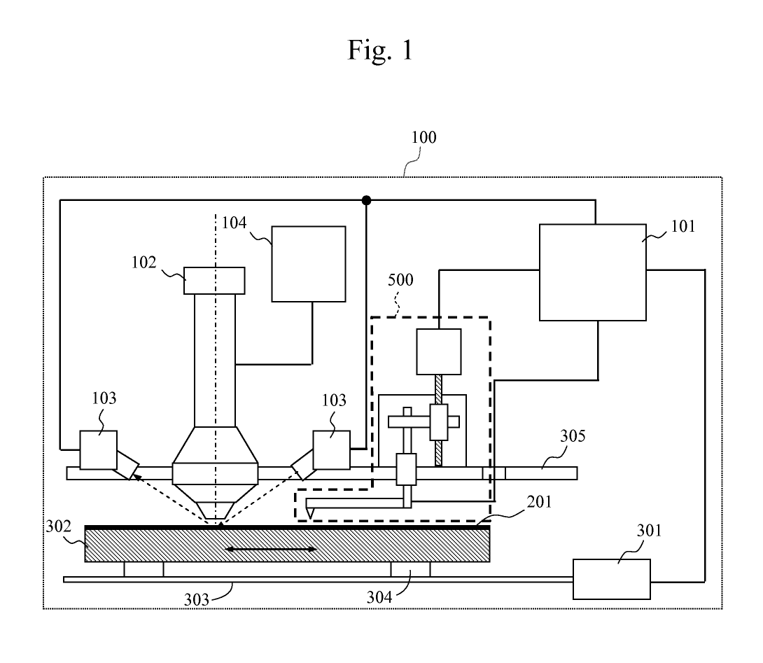

FIG. 1 illustrates an overall configuration example of a wafer defect review apparatus according to an embodiment of the present invention. In the flowing description, a scanning electron microscope-based defect review apparatus will be cited as an example of the wafer defect review apparatus. The present invention is also applicable to an optical defect review apparatus, however.

A scanning electron microscope-based defect review apparatus 100 includes a control PC 101, a scanning electron microscope column 102, a height detection sensor 103, a display monitor 104, a sample stage drive motor 301, a sample stage 302, a sample stage ball screw 303, a sample stage guide 304, and a sample stage lid 305. The scanning electron microscope-based defect review apparatus 100 drives the sample stage on the basis of the inspection coordinate data of a higher-order apparatus; rapidly moves the position of a foreign substance or a defect (both are hereinafter collectively and simply referred to as “defect”) in a semiconductor wafer 201 inspected in the higher-order apparatus into the visual field of the scanning electron microscope column 102; acquires a defect image to display the image on the display monitor 104; and stores the image in the control PC 101. After the completion of defect review, the scanning electron microscope-based defect review apparatus 100 forms, in the semiconductor wafer 201, targets used to cut out a defective portion to be analyzed into a chip form using a subsequent-stage analyzer. To that end, the impression needle is pressed against the semiconductor wafer 201 with an impression marking apparatus 500 to form impressions to serve as the targets.

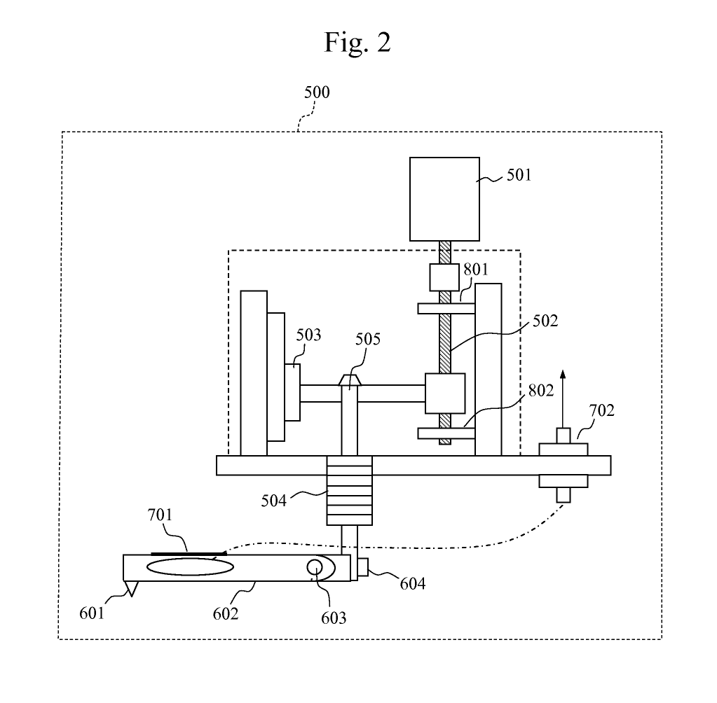

FIG. 2 illustrates details on the impression marking apparatus 500. The impression marking apparatus 500 is equipped with a drive motor 501, a drive ball screw 502, a drive guide 503, a vacuum bellows 504, an arm shaft 505, an impression needle (Berkovich indenter) 601, and a needle arm 602. The drive motor 501 rotates the drive ball screw 502 to raise or lower the arm shaft 505 by the guide of the drive guide 503. The needle arm 602 fixed on the arm shaft 505 moves up and down along with the ascent/descent operation of the arm shaft 505. The impression needle (Berkovich indenter) 601 is fixed on the leading end of the needle arm 602 and moves up and down along with the ascent/descent operation of the needle arm 602. Thus, the impression marking apparatus 500 presses the impression needle 601 against the semiconductor wafer 201 to form impressions.

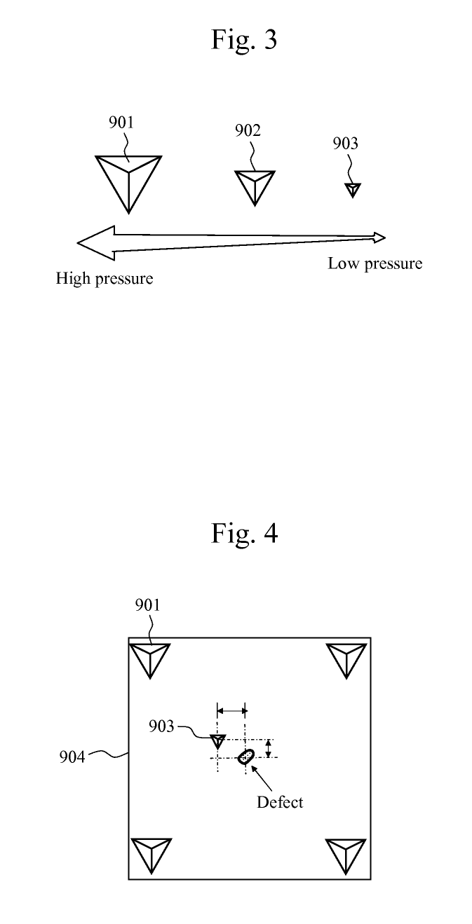

A strain gauge 701 is built in the needle arm 602. The pressing pressure of the impression needle 601 on the semiconductor wafer 201 is controlled using the amount of strain indicated by the strain gauge 701 as a guide, when the impression needle 601 is pressed against the semiconductor wafer 201 to form impressions. Thus, the size of an impression shape is controlled as illustrated in FIG. 3. In the case of, for example, impression marks used to cut out and process a flawed area of the wafer into the shape of a cutout chip 904 as illustrated in FIG. 4, the setting of the strain gauge 701 is set to a large value to set a high pressure. This method forms deep, large impression marks 901 easy to observe visually. For the purpose of identifying a defective location in the cutout chip 904, the setting of the strain gauge 701 is set to a small value and the impression needle 601 is pressed against a portion extremely close to the defective location. This method sets the impression needle 601 to a low pressure and, therefore, forms a shallow, small impression. Consequently, an small impression mark 903 so small as not to affect the defect is formed in the vicinity thereof. The impression mark can be easily identified with an alignment microscope or the like attached to the subsequent-stage analyzer.

Note that positions to attach impressions to and the number of impressions to be attached for one defect can be specified as a direction, a distance and a quantity predetermined with respect to a defect position. Position coordinate data on defects has been previously passed from a higher-order defect inspection apparatus to the scanning electron microscope-based defect review apparatus 100 and is therefore known. Accordingly, once a determination is made that impressions should be attached to a specific defect, positions to form impressions in for the defect can be determined by computation.

The speed of bringing the impression needle 601 into contact with the semiconductor wafer 201 at the time of forming impressions thereon has to be as extremely low as, for example, 100 nm/sec or lower. If the contact speed is high, cracks or the like may arise in the vicinity of impressions, thus possibly producing foreign substances or causing damage to the defect. On the other hand, a distance over which the impression needle 601 is moved at a low contact speed has to be shortened as much as possible. Otherwise, the amount of time taken to form impressions becomes extremely large, thus significantly degrading throughputs. In other words, the impression needle 601 has to be previously brought extremely close to a surface of the semiconductor wafer at a high speed, and then lowered at a low contact speed. Hence, in the present embodiment, the surface height of locations of the semiconductor wafer 201 to form impressions in are previously measured using the height detection sensor 103 attached to the scanning electron microscope-based defect review apparatus 100. This method enables the leading end of the impression needle 601 to move close to a surface of the semiconductor wafer 201 at a high speed. As a result, it is possible to shorten the distance over which the impression needle is moved at an extremely low contact speed. Thus, the time taken to form impressions can be greatly shortened to contribute to improving throughputs.

Heightwise alignment between the height detection sensor 103 attached to the scanning electron microscope-based defect review apparatus 100 and the impression needle 601 is achieved as described below. First, the original focal position of the scanning electron microscope-based defect review apparatus 100 is measured with the height detection sensor 103. Next, the sample stage 302 is driven to move the point of measurement to immediately below the impression needle 601 of the impression marking apparatus 500. Then, the impression needle 601 is moved up and down and brought into contact with the original focal position. The height information of the height detection sensor 103 and the impression needle 601 at that time is recorded and corrected.

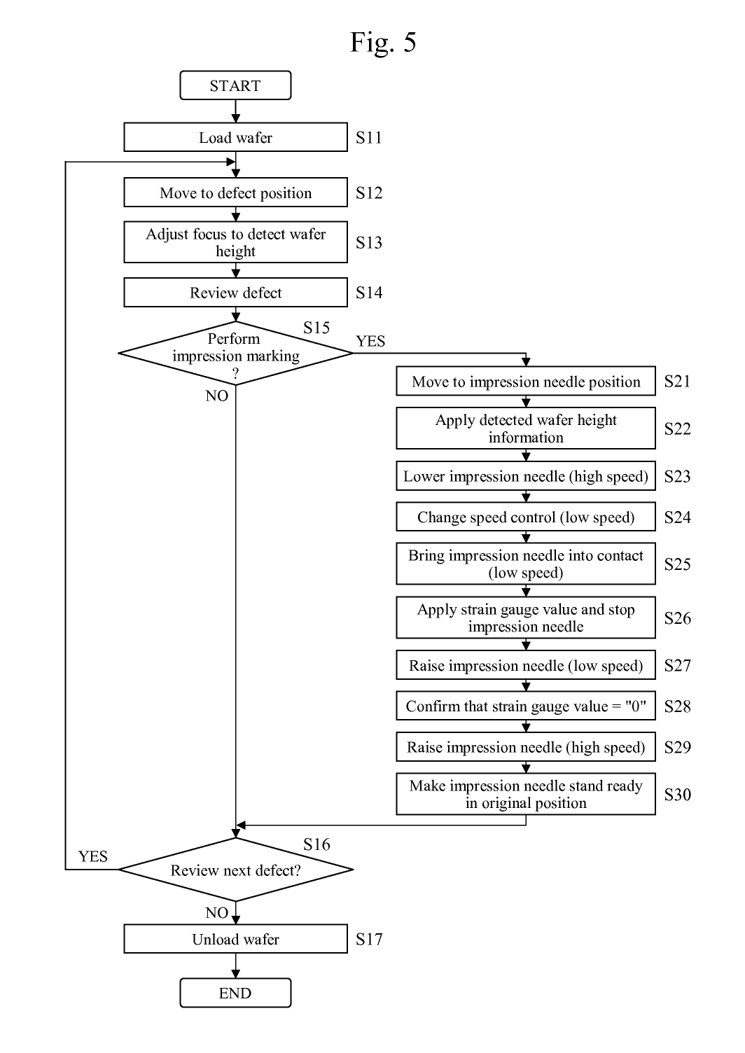

FIG. 5 is a flowchart used to describe a flow of defect review and impression marking operation according to an embodiment of the present invention.

The semiconductor wafer 201 inspected in the higher-order apparatus is carried into the scanning electron microscope-based defect review apparatus equipped with the impression marking apparatus (S11). The sample stage 302 mounted with the carried-in semiconductor wafer 201 is driven at a high speed, on the basis of inspection data provided by the higher-order inspection device, to move a defective location into the visual field of the scanning electron microscope column 102 (S12). Next, the surface height of the semiconductor wafer 201 is measured with the height detection sensor 103 to apply the information thus acquired as information for calculating the focal value of the scanning electron microscope column 102, thereby instantly adjusting the focus of the scanning electron microscope column 102 (S13). Thereafter, an image of a defect position is captured to conduct defect review (S14). A determination is made, according to the results of defect review, whether or not impression marking is performed (S15).

If the defect in question is desired to be observed in the subsequent-stage analyzer, preparations are made to form impression marks around the defect and produce a cutout chip. That is, the system goes from step 15 to step 21, moves the sample stage 302 to below the impression marking apparatus 500 at a high speed, and fine-adjusts the sample stage 302, so that the impression needle is positioned above a location to form an impression mark in (S21). Next, the system rotates the drive ball screw 502 by the drive motor 501, to lower the arm shaft 505 down from a home position (original position) by the guide of the drive guide 503. At that time, the height information provided by the height detection sensor 103 applied to the defect as the focal value information of the scanning electron microscope column 102 is applied to the impression marking apparatus 500 (S22) to move the impression needle 601 extremely close to the surface of the semiconductor wafer 201, for example, to a height 5 μm above the wafer surface at a high speed, for example, at 100 μm/sec (S23). Next, the lowering speed of the impression needle 601 is changed from a high speed to a low speed (S24) to drive the impression needle 601 at a low speed, for example, at 100 nm/sec, thereby bringing the impression needle 601 into contact with the semiconductor wafer 201 (S25). Note that in the present embodiment, the lowering speed of the impression needle is controlled in two steps, i.e., high and low speeds. Alternatively, the lowering speed of the impression needle may be controlled in three steps, i.e., high, medium and low speeds, or in four or more steps in all by setting two or more steps between the high and low speeds.

Next, the output value of the strain gauge 701 built in the needle arm 602 is monitored. The threshold of the strain gauge 701 has been previously changed according to the shape of impression marks to be formed. In the case of impression marks used to create a cutout chip, the threshold of the strain gauge 701 is set to such a large value as 200 mN. At this setting, the large impression marks 901 are formed. In the case of impression marks used to identify a defective location within the cutout chip, however, the threshold of the strain gauge 701 is set to such a small value as 50 mN. At this setting, the small impression mark 903 is formed. A medium-sized impression mark 902 can also be formed if, for example, the defect desired to be observed is relatively large. When the output value of the strain gauge 701 reaches the preset threshold, the impression needle stops (S26). Thereafter, the impression needle 601 is driven and raised at a low speed (S27).

The output value of the strain gauge 701 is monitored also at this point. At the moment when an output value of “0” of the strain gauge 701 can be confirmed (S28), the rising speed of the impression needle 601 is changed to a high speed to further raise the impression needle 601 (S29). Upon arrival at an original standby position, the impression needle 601 is stopped and made to stand ready there (S30).

Thereafter, a determination is made whether or not a review is made of the next defect (S16). If yes, the system goes back to step 12 and moves the sample stage 302 to coordinates of the next defect. Hereafter, a defect review is made in the same way as described above.

If there is no need for impression marking as the result of defect review in the determination in step 15, the system goes to step 16, and a determination is made whether or not a review is made of the next defect. If a determination is made in step 16 that defect review is completed, the semiconductor wafer 201 is carried out of the scanning electron microscope-based defect review apparatus (S17), and defect review and impression marking on the semiconductor wafer are completed. The semiconductor wafer carried out of the scanning electron microscope-based defect review apparatus is subjected to processing on the shape of the cutout chip 904 on the basis of impressions attached to a surface of the wafer.

In order to attach correctly-shaped impressions, the impression needle 601 has to be arranged perpendicularly to the semiconductor wafer 201. Hence, the system is equipped with a mechanism for adjusting the needle arm 602 in Z and θ directions. This adjustment mechanism includes needlepoint adjusters 603 (Z direction) and 604 (θ direction). The needlepoint adjuster (Z direction) 603 can adjust an impression shape in a direction along an axis formed when the long axis of the needle arm 602 is projected onto the semiconductor wafer, by rotating the needle arm 602 in fine angles around the pivotal axis thereof located near the neck of the needle arm 602. In addition, the needlepoint adjuster (θ direction) 604 can adjust an impression shape in a direction perpendicular to the long axis of the needle arm by rotating the needle arm 602 in fine angles around the long axis thereof.

The impression marking apparatus 500 is equipped with an original point limit sensor 801 and a contact limit sensor 802, in case of the drive motor 501 being uncontrollable at the time of forming impressions. Thus, ascent and descent limit positions are monitored using the contact limit sensor 802. If, for example, the drive motor 501 becomes uncontrollable during the formation of impressions, the driving power supply of the drive motor 501 is turned off to prevent any abnormal pressure from being applied to the semiconductor wafer 201. In addition, mechanical dimensions with which a descent position can be mechanically limited are adopted to prevent any abnormal pressure from being applied to the semiconductor wafer 201 to cause damage to the wafer.

As described above, according to the present embodiment, an impression marking mechanism which can be driven in a direction perpendicular to a surface of a semiconductor wafer serving as an inspection object and the leading end of which is acicular is provided in a scanning electron microscope-based defect review apparatus for emitting an electron beam to a sample to observe the sample. Positions to put marks in are determined from coordinate information on a foreign substance or a defect previously acquired with the defect review apparatus. In addition, the feed rate of the impression marking mechanism in the vertical direction thereof is determined from height information acquired with a wafer surface height detection sensor provided in the defect review apparatus. Consequently, high-quality marks can be made easily available.

In addition, according to the present embodiment, the impression marking mechanism has a configuration in which an impression needle is fixed, in a direction perpendicular to a surface of a semiconductor wafer, on the leading end of a lever arranged almost perpendicularly to a feed mechanism movable in a direction perpendicular to the wafer surface, the mounting angle of the lever with respect to the feed mechanism is made adjustable, and the impression marking mechanism is provided with a load meter for measuring a pressing force applied when the impression needle of the lever makes contact with a sample. Consequently, marking can be performed at low costs.

Yet additionally, according to the present embodiment, the feed rate of the impression marking mechanism in the vertical direction thereof is adjusted in at least two steps on the basis of the height information. This method enables impression marking to be performed in a shorter period of time.

Still additionally, the feed rate of the impression marking mechanism in the vertical direction thereof is controlled on the basis of the output of the load meter. This method enables marks to be formed on a sample with even more excellent repeatability.

It should be noted that the present invention is not limited to the foregoing embodiment but encompasses various modified examples. For example, the foregoing embodiment has been described in detail for the purpose of easier understanding of the present invention and is, therefore, not necessarily limited to apparatuses including all of the configurations mentioned above. In addition, part of the configuration of one embodiment may be substituted for the configuration of another embodiment, or the configuration of another embodiment may be added to the configuration of one embodiment. Yet additionally, part of the configuration of each embodiment may be added, deleted or substituted in other configurations.

### DESCRIPTION OF SYMBOLS

100: Scanning electron microscope-based defect review apparatus
101: Control PC
102: Scanning electron microscope column
103: Height detection sensor
104: Display monitor
201: Semiconductor wafer
301: Sample stage drive motor
302: Sample stage
303: Sample stage ball screw
304: Sample stage guide
305: Sample stage lid
500: Impression marking apparatus
501: Drive motor
502: Drive ball screw
503: Drive guide
504: Vacuum bellows
505: Arm shaft
601: Impression needle
602: Needle arm
603: Needlepoint adjuster (Z direction)
604: Needlepoint adjuster (θ direction)
701: Strain gauge
702: Feedthrough
801: Original point limit sensor
802: Contact limit sensor
901: Large impression mark
902: Medium-sized impression mark
903: Small impression mark
904: Cutout chip

What is claimed is:

1. A sample observation apparatus for reviewing a defect in a semiconductor wafer, the apparatus comprising:
a sample stage configured to move with a semiconductor wafer to serve as a sample mounted thereon;
a height detection sensor for detecting the surface height of the sample mounted on the sample stage; and
an impression marking mechanism for driving an impression needle in a direction perpendicular to a surface of the sample to put marks on the sample surface,
wherein a position to put a mark in on the surface of the sample with the impression needle is determined on the basis of coordinate information on a defect in the sample previously acquired with the sample observation apparatus, the feed rate of the impression needle in the vertical direction thereof is determined from height information on the sample acquired with the height detection sensor, the sample stage is driven on the basis of the coordinate information, and the impression marking mechanism is driven on the basis of the height information.

2. The sample observation apparatus according to claim 1, wherein the impression marking mechanism has a configuration in which the impression needle is fixed on the leading end of a lever arranged almost perpendicularly to a feed mechanism movable in a direction perpendicular to the surface of the sample, the mounting angle of the lever is adjustable with respect to the feed mechanism, and the lever is provided with a load meter for measuring a pressing force applied when the impression needle makes contact with the sample.

3. The sample observation apparatus according to claim 1, wherein the feed rate of the impression marking mechanism in the vertical direction thereof can be adjusted in at least two steps on the basis of the height information.

4. The sample observation apparatus according to claim 1, wherein the feed rate of the impression marking mechanism in the vertical direction thereof is controlled on the basis of the output information of the load meter.
